(19) United States
(12) Patent Application Publication
(10) Pub. No.: US 2005/0212172 A1
(43) Pub. Date: Sep. 29, 2005

(54) Solution casting method

(75) Inventor: Satoshi Sakamaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,835

(22) Filed: Mar. 29, 2005

(30) Foreign Application Priority Data
Mar. 29, 2004 (JP) 2004-094580

(51) Int. Cl. B29C 39/00

(52) U.S. Cl. 264/216; 264/288.4; 264/217

(57) ABSTRACT

A dope containing Tac is cast onto a belt. When having self-supporting properties, the dope is peeled as a wet film from the belt, and transported to a tenter dryer. In an entrance section, a preheating is made and in an stretching section a stretching is made at a stretch speed Y(%/min). In a relaxation section, the width of the film was becomes shorter, and in the exit section, the width was kept to be uniform and transported toward the tenter dryer. A difference of a content of the remaining solvent between the stretching starting point and a relaxation end position is X. In this case, the following formula is satisfied to reduce the generation of bowing phenomena. Thus the axial diffractive of a slow axis can be reduced.

### BACKGROUND OF THE INVENTION

1. Field of the Invention

The present invention relates to a solution casting method of producing a film which is preferably used in an electronic display.

2. Description Related to the Prior Art

A polymer is used in several manners. For example, a film is produced from cellulose acylate (hereinafter TAC) and used as a base film of a photosensitive material or a protective film for a polarizing filter in a liquid crystal display (LCD). As already known methods for producing the polymer film, there are a melt-extrusion method in which the polymer is melt with heating and an extrusion thereof is made to obtain the film, and a solution casting method in which a dope containing the polymer, a solvent and the like is prepared and the casting of the dope is made to obtain the film. The film obtained in the solution casting method is excellent in an optical isotropy and therefore used as an optical film (Japan Institute of Invention and Innovation (JIII) JOURNAL of Publication No. 2001-1745).

The LCD is generally used for a personal computer, a monitor of a mobile device and a television in view of several merits, such as low voltage, low electric power requirement, miniaturization and thinner shape. There are several modes of such LCD corresponding to arrangement of liquid crystal molecules in a liquid crystal cell. In the prior art, a TN mode is popular, in which the liquid crystal molecules are twisted at about 90° to lower and upper bases.

Usually, the liquid crystal display is constructed of the liquid crystal cell, an optical compensation sheet and a polarizer. The optical compensation sheet is used for reducing the coloring of an image or widening a view angle. In order to obtain the optical compensation sheet, a transparent film or a birefringence film after the stretching is coated with a liquid crystal material. For example, as described in Japanese Patent No. 2587398, a triacetylcellulose film is coated with a discotic liquid crystal material to obtain an optical compensation sheet in which orientations of liquid crystal molecules are fixed, and the optical compensation sheet is used with the liquid crystal cell of the TN mode. Thus the view angle becomes wider. Further when the liquid crystal display is used for the TV monitor, viewers watches the TV monitor in several directions. Therefore, it is required that the view angle should be wider. However, the requirement is hardly satisfied in the above liquid crystal display and a method of producing thereof. Accordingly, the search of the liquid crystal display is made for IPS (In-Plane Switching) mode, OCB (Optionally Compensatory Bend) mode, VA (Vertically Aligned) mode and the like that are different from the TN mode. Especially the VA mode attracts attentions for using as the TV monitor, since having a high contrast and a lower process yield.

Otherwise, the optical compensation sheet (or a retardation film) of the liquid crystal display is required to have optical anisotropy (high retardation value). Especially, in the optical compensation sheet for the VA mode LCD, it is necessary that the in-plane retardation (Re) is from 30 nm to 200 nm and the thickness retardation (Rth) is from 70 nm to 400 nm. Therefore, as the optical compensation sheet, a synthetic polymer film whose retardation value is high is used, for example a polycarbonate film, a polysulfone film and the like. optical materials, the synthetic polymer film is used when the optical anisotropy (high retardation value) is required, and the celluloseacetate film is used when the optical isotropy (low retardation) is required.

However, the International Patent Publication No. 0055657 teaches a cellulose triacetate film which has a high retardation value enough for the use in case of the requirement of the optical anisotropy. In order to provide the high retardation value for the cellulose triacetate film, aromatic compounds having at least two aromatic rings, especially 1,3,5-triazine rings, are contained in the film, and the stretching of the film is made.

Usually, the cellulose acetate film is hardly stretched, and therefore it is difficult to increase the birefringence. However, when additives are oriented simultaneously by the stretching, the birefringence increases and the retardation value becomes high. In this case, since the cellulose acetate film also has a function of a protective film for a polarizing filter, the low-cost and thin liquid crystal display can be supplied in the market.

Japanese Patent Laid-Open Publication No. 2002-7195 teaches an optical film containing cellulose esters which has substituents of acyl groups having 2-4 carbon atoms. This cellulose esters simultaneously satisfy following formulae, if the acetylation degree is A and the degree of substitution of propionyl group or butylyl group is B: 2.0≦A+B≦3.0 and A<2.4. Further, a refractive index Nx of wave at 590 nm wavelength along a slow axis and a refractive index Ny of wave along a fast axis satisfy a formula 0.0005≦Nx−Ny≦0.0050. Further, Japanese Patent Laid-Open Publication No. 2002-270442 teaches a polarizing filter used for the VA mode liquid crystal display. This polarizing filter includes a polarizer and an optically biaxial film formed from cellulose esters of mixed aliphatic acids.

In a solution casting method, a dope is cast onto a support to form a casting film. Then the casting film is peeled as a film when having a self-supporting property. The film is transported to a tenter dryer and dried therein with stretching in a widthwise direction. Thereafter the drying is further made, the edge portions are slit off, and the film is wound up. The film is adhered onto a polarizer that the polarizing filter is obtained.

When the retardation film is adhered to the polarizing filter, it is preferable that a direction of the slow axis is a crosswise direction of the polarizing filter. The stretching of the film is preferably made in the widthwise direction. In view of the uniformity and smoothness and the like, the film produced by the solution casting method is preferable. Further, for increasing of the productivity, the stretching is preferably made in a film production line. In the stretching in the widthwise direction by the tenter dryer, a bowing phenomena occurs, and tehrefore the direction of the slow axis is different from the widthwise direction. A research of such phenomena is progressive in the biaxial stretching of the polyester film, and the biaxial stretching of the polyester film produced by the melt-extrusion method is searched. Thus several methods of improvements are proposed.

For example, in the melt-extrusion method, a bowing phenomena occurs by the stretching, and therefore middle part may be backward to edge parts of the continuous film. However, about the bowing phenomena of the solution casting method, the middle part may be frontward to the edge parts of the continuous film. Japanese Patent Laid-Open Publication No. 2002-296422 teaches following methods of reducing the bowing phenomena during the stretch of the film containing a solvent.
1) using cellulose ester having predetermined degree of substitution;
2) making the temperature in edge portions of the film higher than a middle portion;
3) making the content of the solvent in the side edge portions larger than the middle portion;
4) sectioning the tenter dryer into plural sections whose temperatures are different.

The methods of the publications No. 2002-7195 & 2002-270442 have merits in view that the thin LCD of low cost can be produced. However, in recent years, it is required to increase the retardation value moreover. Therefore it is necessary that the amount of a retardation controller to be added is made larger and the stretch ratio is increased. However, in the bowing phenomena, the stretch ratio in the tenter dryer increases the distribution of the direction slow axes in the widthwise direction.

The method described in the publication 2002-296422 has large efficiencies. However, since the contrast ratio and the brightness of the LCD are increased in the recent years, it is required moreover to prevent that the direction of the slow axis of the optical film becomes different from the widthwise direction of the film. Therefore, it is too hard to satisfy this requirement only by the above methods. Further, if different heating sections in the tenter dryer or the accurate temperature control in the widthwise direction of the web is provided, the number of the heating devices and the controlling devices becomes larger. Thus the structure becomes complicated, and the cost for the equipment becomes higher.

Further, when the stretch in the widthwise direction is made by the tenter dryer to make the orientation of the polymer molecules, the direction of the slow axis becomes different from the widthwise direction of the film in the bowing phenomena. However, since the contrast ratio and the screen brightness of the LCD are increased in the recent years, it is required moreover to prevent the difference of the direction of the slow axis from the widthwise direction of the optical film.

### SUMMARY OF THE INVENTION

An object of the present invention is to provide

Another object of the present invention is to provide

In keen examination, the inventor knew that the direction of the slow axis can be extremely excellently uniform by in the following steps without complicated thermal gradient: (1) after enlarging the thickness of the film, the relaxation for decreasing the width; (2) when X is defined as a content difference (wt. %) of a remaining solvent in the film between starting the enlarging and ending the relaxation and Y is defined as an enlarging speed (%/min) in the enlarging. In Publication No. 0999656A2 teaches that the bowing direction is frontward when the enlarging of the width is made by the solution casting method. The inventor found that the bowing phenomena can be changed between the frontward bowing and the backward bowing by restricting the content difference X and the stretch speed Y. Thus the bowing can be made substantially flat.

In order to achieve the object and the other object, in a solution casting method of the present invention, a dope containing a polymer and a solvent is cast onto a support, and dried. Then the dope is peeled as a film and a width of the film is enlarged with holding both edge portions of the film by a holding device. With continuing the holding, a relaxation is performed such that the width becomes shorter by a predetermined value. When X is defined as a content difference (wt. %) of a remaining solvent in the film between starting the enlarging and ending the relaxation and Y is defines as an enlarging speed (%/min) in the enlarging, the enlarging and the relaxation are performed so as to satisfy a following formula, −5.0<0.27X+1.01XY−21.2<5.0

Preferably, the polymer is cellulose acylate. Further, a temperature for heating the film is almost constant while a width of the holding device changes. Furthermore, an angular deflection of a slow axis to a widthwise direction of the film is preferably less than 2°, particularly less than 1.0°, and especially less than 0.5°.

The present invention is applied to the film produced by the solution casting method, and further a polarizing filter in which the film is used as a protective film, and a liquid crystal display in which the polarizing filter is used.

In the solution casting method of the present invention, the dope containing the polymer and the solvent is cast onto the support, and then the drying and the peeling are made. Thereafter, while both edges are held by a holding device, the stretch and the relaxation are made such that the film may be obtained. In the stretch, a width of the film becomes larger, and in the relaxation, the width of the film becomes smaller at a predetermined value. A content difference of the remaining solvent in the film before the stretch to that after the relaxation is X(wt. %) and an averaged strech speed (%/min). In thie case, the relaxation is made so as to satisfy the formula −5.0<0.27X+1.01XY−21.2<5.0. Therefore the generation and the form of bowing phenomena are reduced. Therefore the bowing phenomena is reduced and the axial misalignment of the slow axis of the birefringence becomes smaller.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production line in which a solution casting method of the present invention is performed;

FIG. 2 is n explanatory view for relaxation of drawing the film in a tenter dryer.

### PREFERRED EMBODIMENTS OF THE INVENTION

In the cellulose acylate to be used in the present invention, the degree of the substitution preferably satisfies all of the following formulae (I)-(III):
2.5≦A+B≦3.0 (I)
0≦A≦3.0 (II)
0≦B≦2.9 (III)

In these formulae, A is a degree of substitution of the hydrogen atom of the hydroxyl group to the acetyl group, and B is a degree of substitution of the hydrogen group to the acyl group having 3-22 carbon atoms. Preferably, at least 90 wt. % of the cellulose acylate particles has diameter from 0.1 mm to 4 mm.

The cellulose is constructed of glucose units making β-1,4 combination, and each glucose unit has a liberated hydroxyl group at second, third and sixth positions. Cellulose acylate is a polymer in which part or whole of the hydroxyl groups are esterified by acyl groups. The degree of substitution for the acyl groups in cellulose acylate is a degree of esterification at second, third or sixth position in cellulose. Accordingly, when all (100%) of the hydroxyl group at the same position are substituted, the degree of substitution at this position is 1.

When the degrees of substitution for the acyl groups at the second, third or sixth positions are respectively described as DS1, DS2, DS3, the total degree of substitution for the acyl groups at the second, third or sixth positions (namely DS2+DS3+DS6) is preferably in the range of 2.00 to 3.00, and particularly in the range of 2.40 to 2.82. Further, DS6/(DS2+DS3+DS6) is preferably at least 0.32, and particularly 0.322, and especially in the range of 0.324 to 0.340.

The sort of acyl group to be contained in the cellulose acylate of the present invention is may be only one, and two or more sorts of the acyl group may be contained. If the number of the sorts of the acyl groups is at least two, it is preferable that one of the sorts is acetyl group. If the total degree of substitution for the acetyl groups and that for other acyl groups at the second, third or sixth positions are respectively is described as DSA and DSB, the value DSA+DSB is preferably in the range of 2.2 to 2.86, and particularly in the range of 2.40 to 2.80. Further, the DSB is preferably at least 1.50, and especially at least 1.7. Further, in substituents of the hydroxyl groups at second, third and sixth positions except of the acetyl groups, the percentage of these substituent are at the sixth position is preferably at least 28%, particularly at least 30%, especially at least 31% and most especially at least 32%. Further, the degree of the acyl groups at sixth position is at least 0.7, particularly at least 0.80, and especially 0.85. From cellulose acylate satisfying the above conditions, a solution (or dope) having a preferable dissolubility can be prepared. Especially when non-chlorine type organic solvent is used, the adequate dope can be prepared, since the dope can be prepared so as to have a low viscosity and the filterability becomes higher.

The acyl group having at least 2 carbon atoms may be aliphatic group or aryl group, and is not restricted especially. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferably substituents are propionyl group, butanoyl group, keptanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

Solvent compounds for preparing the dope are aromatic hydrocarbon (for example, benzene toluene and the like), halogenated hydrocarbons (for example, dichloromethane, chloroform, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like.

The preferable solvent compounds are the halogenated hydrocarbons having 1 to 7 carbon atoms, and dichloromethane is especially pref erable. In view of physical properties such as optical properties, a solubility, a peelability from a support, a mechanical strength of the film and the like, it is preferable to use at least one sorts of the solvent compounds having 1 to 5 carbon atoms. The content of the alcohols is preferably in the range of 2 wt. % to 25 wt. %, and especially in the range of 5 wt. % to 20 wt. % to total solvent compounds in the solvent. As concrete example of the alcohols, there are methanol, ethanol., n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, or a mixture of them. The ethers, ketones, esthers may have a cyclic structure, and at least two solvent compounds having at least two functional groups thereof (—O—, —CO—, —COO—) may be contained in the organic solvent. In this case, the number of carbon atoms may be at most the predetermined values for each compound of the functional group. Note that the organic solvent compound may have other functional group such as alcoholic hydroxyl group.

The cellulose acylate is described in detail in the Japanese patent application No. 2003-319673, and the description of this applycation can be applied to the present invention. Further, as the solvent of cellulose acylate and other additives, this applycation discloses plasticizers, deteoriation inhibitor, optical anisotropy controlling agent, dye, matting agent, peeling agent are in detail.

In the present invention, preferably, one or more UV-absorbing agent is preferable to be contained in the solution. Since having the dimensional stability, the cellulose acylate film is used in the polarizing filter, the liquid crystal display and the like. In view of the protection of the deterioration of liquid crystal compounds, the UV-absorbing agent is preferably excellent in absorbing UV-ray whose wave length is equal or less than 370 nm. Further, in view of the displayability of the liquid crystal, the UV-absorbing agent preferably does not absorb visible ray whose wave length is equal or more than 400 nm. As the UV-absorbing agent, there are, for example, oxybenzophenone type compounds, benzotriasol type compounds, salicylic acid ester type compounds, benzophenone type compounds, cyanoacrylate type compounds, nickel complex salt type compounds.

As the preferable UV-absorbing agent, there are
2-(2′-hydroxy-5′-methylphenyl)benzotriazol;
2-(2′-hydroxy-3′,5′-di-tert-butylphenyl)benzotriazol;
2-(2′-hydroxy-3′-tert-butyl-5′-methylphenyl)benzotriazol;
2-(2′-hydroxy-3′,5′-di-tert-butylphenyl)-5-chlorobenzotriazol;
2-(2′-hydroxy-3′-(3″,4″,5″,6″-tetrahydrophthalimidomethyl)-5′-methylphenyl)benzotriazol;
2,2-methylenebis(4-(1,1,3,3-tetramethylbutyl)-6-(2H-benzotriazol-2-yl)phenol);
2-(2′-hydroxy-3′-tert-butyl-5′-methylphenyl)-5-chlorobenzotriazol; 2,4-dihydroxybenzophenone; 2,2′-dihydroxy-4-metoxybenzophenone; 2-hydroxy-4-metoxy-5-sulfobenzophenone; bis(2-metoxy-4-hydroxy-5-benzoylphenylmethane); (2,4-bis-(n-octylthio)-6-(4-hydroxy-3,5-di-tert-butylanylino)-1,3,5-triazine; 2-(2′-hydroxy-3′,5′-di-tert-butylphenyl)-5-chlorobenzotriazol; (2(2′-hydroxy-3′,5′-di-tert-amylphenyl)-5-chlorobenzenetriazol; 2,6-di-tert-butyl-p-crezol; pentaerythrityl-tetrakis[3-(3,5-di-tert-butyl-4-hydroxyphenyl)propionate]; triethylene glycol-bis[3-(3-tert-butyl-5-methyl-4-hydroxyphenyl)propionate]; 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triadine; 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocine amide), 1,3,5-trimethyl-2,4,6-tris(3,5-di-tert-butyl-4-hydroxybenzyl)benzene, tris-(3,5-di-tert-butyl-4-hydroxybenzyl)-isocianurate and the like. Especially preferable are 2,4-bis-(n-octylthio)-6-(4-hydroxy-3,5-di-tert-butylanylino)-1,3,5-triadine; 2(2′-hydroxy-3′,5′-di-tert-butylphenyl)-5-chlorobenzotriazol; (2(2′-hydroxy-3′,5′-di-tert-amylphenyl)-5-chlorobenzotriazol; 2-(2′-hydroxy-3′,5′-di-tert-butylphenyl)-5-chlorobenzotriazol; 2,6-di-tert-butyl-p-crezol, pentaerythrityl-tetrakis[3-(3,5-di-tert-butyl-4-hydroxyphenyl)propionate]; and triethyleneglycol-bis[3-(3-tert-butyl-5-methyl-4-hydroxyphenyl)propionate]. Further, the following compound can be used simultaneously; for example, metallic nonactivator of hydradine type, such as N,N′-bis[3-(3,5-di-tert-butyl-4-hydroxyphenyl)propionyl]hydradine, processing stabilizers of phosphor type, such as tris(2,4-di-tert-butylphenyl)phosphite and the like. The added amount of these compound is preferably 1 ppm to 2.0% in mass ratio to cellulose acylate, and particularly 10 ppm to 5000 ppm.

Further, it is preferable to use the UV-absorbing agents described in Japanese Patent Laid-Open Publications No. 6-148430 & 7-11056. The UV-absorbing agents preferably used in the present invention have high transparency and high efficiency for preventing the deterioration of the polarizing filter or the liquid crystal elements. Especially preferable are the benzotriazol type UV-absorbing agents which reduces the unnecessary coloring. The quantity of the UV-absorbing agent to be used in not constant and depending on the sorts of the compounds, the conditions of use and so on. However, the quantity is preferably in the range of 0.2 g to 5.0 g, and preferably in the range of 0.4 g to 1.5 g, and especially in the range of 0.6 g to 1.0 g in 1 m² cellulose acylate film.

As the UV-absorbing agents to be used in the present invention, there are optical stabilizer in catalogue of “Adekastab”, optical stabilizers and UV-absorbing agents in catalogue of Tinuvin of Ciba Special Chemicals, SEESORB, SEENOX, SEETEC and the like in catalogue of SHIPRO KASEI KAISHA. Further, there are VIOSORB of Kyodo Chem. Co. Ltd and UV-absorbing agents of Yoshitomi Pharmaceut Ind., Ltd.

Japanese Patent Laid-Open Publication No. 2003-043259 discloses the optical film to be used in the polarizing filter and the displaying device. The film is excellent in color reproducibility and endurance in the illumination of the UV-ray. In the UV-wavelength range, the spectral transmittance of the film is from 50% to 95% at 390 nm and at most 5% at 350 nm of UV-wave.

The compounds to be used as optical anisotropy controlling agents will be described in followings. 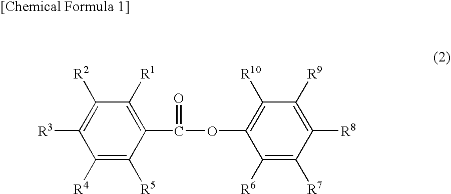
In the formula (2), R¹-R¹⁰ are independently hydrogen atom or substituent T which will be explained later. At least one of R¹-R⁵ is an electron donative substituent. The substituent having electron-donating property is preferably at least one of R¹, R³ and R⁵, and especially R³.

In the group having electron-donating property, a σp value of Hammet is at most zero. The σp value of Hammet described in Chem. Rev., 91, 165(1991) is preferably at most zero, and especially in the range of −0.85 to 0. Such groups are, for example, alkyl groups, alkoxyl groups, amino groups, hydroxyl groups, and the like.

The groups having electron-donating property are preferably alkyl groups and alcoxy groups, and particularly alcoxy groups in which the number of carbon atoms is preferably from 1 to 12, particularly from 1 to 8, especially from 1 to 6, and more especially 1 to 4.

R¹ is preferably hydrogen atom or a substituent having electron-donating property, particularly alkyl group, alcoxy group, amino group and hydroxyl group, and especially alkyl group having 1-4 carbon atoms and alcoxy group having 1-12 carbon atoms. R¹ is more especially alcoxy group in which the number of carbon atoms is preferably from 1 to 12, particularly from 1 to 8, especially from 1 to 6, and more especially 1 to 4, and most especially methoxy group.

R² is preferably hydrogen atom, alkyl group, alcoxy group, amino group and hydroxyl group, particularly hydrogen atom, alkyl group and alcoxy group. R² is more especially hydrogen atom, alkyl group which has 1-4 carbon atoms or is further preferably methyl group, alcoxy group in which the number of carbon atoms is preferably from 1 to 12, particularly from 1 to 8, especially from 1 to 6, and more especially 1 to 4, and most especially methoxy group. The most especially group as R² is hydrogen atom, methyl group and methoxy group.

R³ is preferably hydrogen atom or a substituent having electron-donating property, particularly hydrogen atom, alkyl group, alcoxy group, amino group and hydroxyl group, and especially alkyl group and alcoxy group. R³ is more especially alcoxy group in which the number of carbon atoms is preferably from 1 to 12, particularly from 1 to 8, especially from 1 to 6, and more especially 1 to 4. R³ is most especially n-propoxy group, ethoxy group and methoxy group.

R⁴ is preferably hydrogen atom or a substituent having electron-donating property, particularly hydrogen atom, alkyl group, alcoxy group, amino group and hydroxyl group, and especially hydrogen atom, alkyl group having 1-4 carbon atoms and alcoxy group having 1-12 carbon atoms. R⁴ is more especially alcoxy group in which the number of carbon atoms is preferably from 1 to 12, particularly from 1 to 8, especially from 1 to 6, and more especially 1 to 4. R⁴ is most especially hydrogen atom, methyl group, and methoxy group.

R⁵ is preferably hydrogen atom, alkyl group, alcoxy group, amino group and hydroxyl group, particularly hydrogen atom, alkyl group and alcoxy group. R⁵ is more especially hydrogen atom, alkyl group which has 1-4 carbon atoms or is further preferably methyl group, and alcoxy group in which the number of carbon atoms is preferably from l to 12, particularly from 1 to 8, especially from 1 to 6, and more especially 1 to 4. The most especially group as R⁵is hydrogen atom, methyl group and methoxy group.

R⁶, R⁷, R⁹ and R¹⁰ preferably hydrogen atom, alkyl group having 1 to 12 carbon atoms, alcoxy group having 1 to 12 carbon atom and halogen atoms, particularly hydrogen atom and halogen atoms, and especially hydrogen atom.

R⁸ is preferably hydrogen atom, alkyl group having 1-4 carbon atoms, alkynyl group having 2-6 carbon atoms, aryl group having 6-12 carbon atoms, alcoxy group having 1-12 carbon atoms, and aryloxy group having 6-12 carbon atoms. R⁸ is particularly preferably alcoxy carbonyl group having 2-12 carbon atoms, acylamino group having 2-12 carbon atoms, ciano group and halogen atom. These groups may have a substituent T which will be explained later.

R⁸ is preferably alkyl group having 1-4 carbon atoms, alkynyl group having 2-6 carbon atoms, aryl group having 6-12 carbon atoms, alcoxy group having 1-12 carbon atoms, aryloxy group having 2-12 carbon atoms, and particularly aryl group having 6-12 carbon atoms, alcoxy group having 1-12 carbon atoms, aryloxy group having 6-12 carbon atoms. R⁸ is especially preferably alcoxy group in which the number of carbon atoms is preferably from 1 to 12, particularly from 1 to 8, especially from 1 to 6, and more especially 1 to 4. The most especially group as R⁸ is methoxy group, ethoxy group, n-propoxy group, iso-propoxy group and n-butoxy group.

In Chemical Formula 1 (formula (2)), there are preferable compounds shown in Chemical Formula 2 (following formula (2-A)).

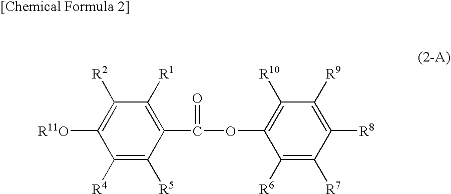

In the formula (2-A), R¹¹ is alkyl group, and R¹, R², R⁴-R⁷, R⁹, R¹⁰ are independently hydrogen atom or substituents. R⁸ is hydrogen atom, alkyl group having 1-4 carbon atoms, alkynyl group having 2-6 carbon atoms, aryl group having 6-12 carbon atoms, alcoxy group having 1-12 carbon atoms, aryloxy group having 6-12 carbon atoms, alcoxy carbonyl group having 2-12 carbon atoms, acylamino group having 2-12 carbon atoms, ciano group and halogen atom. In Chemical Formula 2 (formula (2-A)), R¹, R², R⁴-R¹⁰ and the preferable range of the number of the carbon atoms in one molecule are the same as in Chemical Formula 1 (formula (2)).

In formula (2-A), R¹¹ is preferably alkyl group having 1-12 carbon atoms, and may have straight chain or branched chain. Further, R¹¹ may have substituents and be preferably alkyl group having 1-12 carbon atoms, particularly alkyl group having 1-8 carbon atoms, especially alkyl group having 1-6 carbon atoms, and more especially alkyl group having 1-4 carbon atoms (for example, methyl group, ethyl group, n-propyl group, iso-propyl group, n-butyl group, iso-butyl group, tert-butyl group and the like.

In Chemical Formula 1 (formula (2)), there are preferable compounds shown in Chemical Formula 3 (following formula (2-B)).

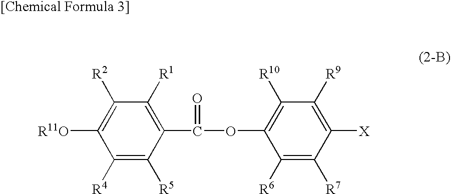

In the formula (2-B), R¹, R², R⁴-R⁷, R⁹, R¹⁰ are independently hydrogen atom or substituents. R¹¹ is a alkyl group having 1 to 12 carbon atoms. X is alkyl group having 1-4 carbon atoms, alkynyl group having 2-6 carbon atoms, aryl group having 6-12 carbon atoms, alcoxy group having 1-12 carbon atoms, aryloxy group having 6-12 carbon atoms, alcoxy carbonyl group having 2-12 carbon atoms, acylamino group having 2-12 carbon atoms, ciano group and halogen atom.

In Chemical Formula 3 (formula (2-B)), R¹, R², R⁴-R⁷, R⁹, R¹⁰ and the preferable range of the number of the carbon atoms in one molecule are the same as in Chemical Formula 1 (formula (2)), and R⁸ and the preferable range of the number of the carbon atoms in one molecule are the same as in Chemical Formula 2 (formula (2-A)).

If R¹, R², R⁴, R⁵ are hydrogen atoms, X is preferably alkyl group, alkynyl group, aryl group, alcoxy group, aryloxy group, and particularly aryl group, alkoxy group, aryloxy group, especially alcoxy group in which the number of carbon atoms is preferably from 1 to 12, particularly from 1 to 8, especially from 1 to 6, and more especially 1 to 4. The most especially preferable group as X is methoxy group, ethoxy group, n-propoxy group, iso-propoxy group and n-butoxy group.

If at least one of R¹, R², R⁴ and R⁵ is substituent, X is preferably alkynyl group, aryl group, alcoxy carbonyl group and ciano group, and preferably aryl group having 6-12 carbon atoms, alcoxy carbonyl group having 2-12 carbon atoms and ciano group. Further, X is especially preferably ciano group, aryl group which has 6-12 carbon atoms (particularly phenyl group, p-cianophenyl group and p-methoxyphenyl group), alcoxycarbonyl group which has preferably 2-12, particularly 2-6 and especially 2-4 carbon atoms and is especially methoxy carbonyl group, ethoxy carbonyl group and n-propoxycarbonyl group. The most especially group as X is phenyl group, methoxy carbonyl group, ethoxy carbonyl group, n-propoxy group and cyano group.

In Chemical Formula 1 (formula (2)), there are preferable compounds shown in Chemical Formula 4 (following formula (2-C)).

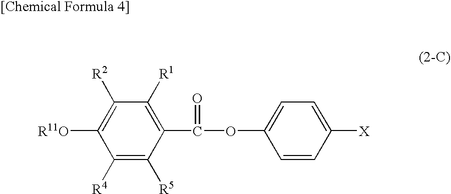

In Chemical Formula 4 (formula (2-C)), R¹, R², R⁴, R⁵, R¹¹ and the preferable range of the number of the carbon atoms in one molecule are the same as in Chemical Formula 3 (formula (2-B)).

In Chemical Formula 1 (formula (2)), there are preferable compounds shown in Chemical Formula 5 (following formula (2-D)).

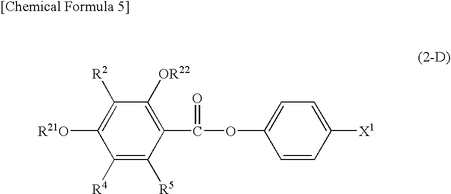

In Chemical Formula 5 (formula (2-D)), R², R⁴, R⁵ and the preferable range of the number of the carbon atoms in one molecule are the same as in Chemical Formula 4 (formula (2)). R²¹,R²² are independently alkyl group having 1-4 carbon atoms. X¹ is aryl group having 6-12 carbon atoms, alcoxylcarbonyl group having 2-12 carbon atoms, or cyano group.

R²¹ is alkyl group having 1-4 carbon atoms, preferably alkyl group having 1-3 carbon atoms, and particularly methyl group and ethyl group. R²² is alkyl group having 1-4 carbon atoms, preferably alkyl group having 1-3 carbon atoms, particularly methyl group and ethyl group, and especially methyl group.

X¹ is aryl group having 6-12 carbon atoms, alcoxyl carbonyl group having 2-12 carbon atoms, and cyano group, and preferably aryl group having 6-10 carbon atoms, alcoxyl carbonyl group having 2-6 carbon atoms, and cyano group. X¹ is especially preferably phenyl group, p-cianophenyl group, p-methoxyphenyl group, methoxycarbonyl group, ethoxy carbonyl group, n-propoxy carbonyl group, and cyano group, and more especially phenyl group, methoxycarbonyl group, ethoxycarbonyl group, n-propoxycarbonyl group, and cyano group.

In Chemical Formula 1 (formula (2)), there are preferable compounds shown in Chemical Formula 6 (following formulae (2-E1), (2-E2), (2-E3)).

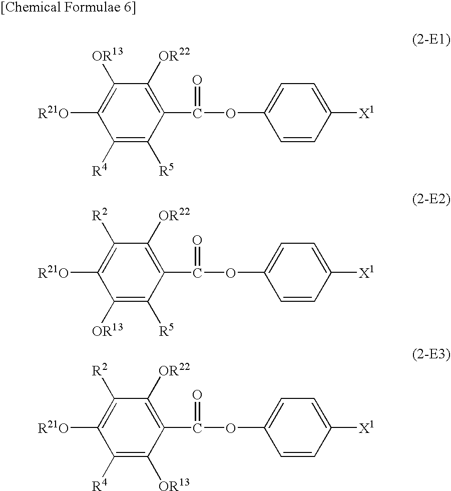

In Chemical Formula 6 (formulae (2-E1), (2-E2), (2-E3)), R², R⁴, R⁵ and the preferable range of the number of the carbon atoms in one molecule are the same as in Chemical Formula 5 (formula (2-D)). As shown in Chemical Formulae 6, OR¹³ is substituent for one of R², R⁴, R⁵, and R¹³ is alkyl group having 1-4 carbon atoms. R²¹, R²², X¹ and the preferable range of the number of the carbon atoms in one molecule are the same as in Chemical Formula 5 (formula (2-D)).

Preferably, both R⁴ and R⁵ are OR¹³, and especially R⁴ is OR¹³. R¹³ is alkyl group having 1-4 carbon atoms, preferably alkyl group having 1-3 carbon atoms, particularly methyl group and ethyl group, and especially methyl group.

In followings, the substituents T will be explained. As the substituents, there are, for example, alkyl groups in which the number of the carbon atoms is preferably from 1 to 20, particularly from 1 to 12, especially from 1 to 8. Concretely, the alkyl group is methyl group, ethyl group, iso-propyl group, tert-butyl group, n-octyl group, n-decyl group, n-hexadecyl gtoup, cyclopropyl group, cyclopentyl group, cyclohexyl group and the like. Further, as the substutuents, there are, for example, alkenyl groups in which the number of the carbon atoms is preferably from 2 to 20, particularly from 2 to 12, especially from 2 to 8 (concretely, vinyl, aryl group, 2-butenyl group, 3-pentenyl group and the like), alkynyl groups in which the number of the carbon atoms is preferably from 2 to 20, particularly from 2 to 12, especially from 2 to 8 (concretely, propargyl group, 3-pentynyl group and the like).

Further, as the substutuents, there are, for example, aryl groups in which the number of the carbon atoms is preferably from 6 to 30, particularly from 6 to 20, especially from 6 to 12. Concretely there are phenyl group, p-methylphenyl group, naphtyl group and the like. Furthermore, as the substutuents, there are, for example, substituted or non-substituted amino groups in which the number of the carbon atoms is preferably from 0 to 20, particularly from 0 to 10, especially from 0 to 6. Concretely, there are amino group, methylamino group, dimethylamino group, diethylamino group, dibenzylamino group, and the like.

Further, as the substutuents, there are, for example, alcoxy groups in which the number of the carbon atoms is preferably from 1 to 20, particularly from 1 to 12, especially from 1 to 8. Concretely, there are methoxy group, ethoxy group, butoxy group and the like. Furthermore, as the substutuents, there are, for example, aryloxy groups in which the number of the carbon atoms is preferably from 6 to 20, particularly from 6 to 16, especially from 6 to 12. Concretely, there are phenyloxy group, 2-naphtyloxy group and the like.

Further, as the substutuents, there are acyl groups in which the number of the carbon atoms is preferably from 1 to 20, particularly from 1 to 16, especially from 1 to 12. Concretely, there are acetyl group, benzoyl group, formyl group, pivaloyl group, and the like. Further, as the substutuents, there are alcoxy carbonyl groups in which the number of the carbon atoms is preferably from 2 to 20, particularly from 2 to 16, especially from 2 to 12. Concretely, there are methoxycarbonyl group, ethoxycarbonyl group and the like. Further, as the substutuents, there are aryloxycarbonyl groups in which the number of the carbon atoms is preferably from 7 to 20, particularly from 7 to 16, especially from 7 to 10. Concretely, there are phenyloxycarbonyl group and the like. Further, as the substutuents, there are acyloxy groups in which the number of the carbon atoms is preferably from 2 to 20, particularly from 2 to 16, especially from 2 to 10. Concretely, there are acetoxy group, benzoyloxy group and the like.

Further, as the substutuents, there are acylamino groups in which the number of the carbon atoms is preferably from 2 to 20, particularly from 2 to 16, especially from 2 to 10. Concretely, there are acetylamino group, benzoylamino group and the like. Further, as the substutuents, there are alcoxycarbonylamino groups in which the number of the carbon atoms is preferably from 2 to 20, particularly from 2 to 16, especially from 2 to 12. Concretely, there are methoxycarbonylamino group and the like. Further, as the substutuents, there are aryloxycarbonylamino groups in which the number of the carbon atoms is preferably from 7 to 20, particularly from 7 to 16, especially from 7 to 12. Concretely, there are phenyloxycarbonylamino group and the like. Further, as the substutuents, there are sulfonylamino groups in which the number of the carbon atoms is preferably from 1 to 20, particularly from 1 to 16, especially from 1 to 12. Concretely, there are methanesulfonyl amino group, benzene sulfonylamino group and the like.

Further, as the substutuents, there are sulfamoyl groups in which the number of the carbon atoms is preferably from 0 to 20, particularly from 0 to 16, especially from 0 to 12. Concretely, there are sulfamoyl group, methylsulfamoyl group, dimethylsulfamoyl group, phenylsulfamoyl group and the like. Further, as the substutuents, there are carbamoyl groups in which the number of the carbon atoms is preferably from 1 to 20, particularly from 1 to 16, especially from 1 to 12. Concretely, there are carbamoyl group, methylcarbamoyl group, diethylcarbamoyl group, phenylcarbamoyl group and the like. Furthermore, as the substutuents, there are alkylthio groups in which the number of the carbon atoms is preferably from 1 to 20, particularly from 1 to 16, especially from 1 to 12. Concretely, there are methylthio group, ethylthio group and the like. Furthermore, as the substutuents, there are arylthio groups in which the number of the carbon atoms is preferably from 6 to 20, particularly from 6 to 16, especially from 6 to 12. Concretely, there are phenylthio group.

Further, as the substutuents, there are sulfonyl groups in which the number of the carbon atoms is preferably from 1 to 20, particularly from 1 to 16, especially from 1 to 12. Concretely, there are mesyl group, tosyl group and the like. Further, as the substutuents, there are sulfinyl groups in which the number of the carbon atoms is preferably from 1 to 20, particularly from 1 to 16, especially from 1 to 12. Concretely, there are methane sulfinyl group, benzene sulfinyl group and the like. Further, as the substutuents, there are ureido groups in which the number of the carbon atoms is preferably from 1 to 20, particularly from 1 to 16, especially from 1 to 12. Concretely, there are ureido group, methylureido group, phenylureido group and the like. Furthermore, as the substutuents, there are phosphoric acid amide groups in which the number of the carbon atoms is preferably from 1 to 20, particularly from 1 to 16, and especially from 1 to 12. Concretely, there are diethylphosphoric acid amide group, phenylphosphoric acid amide group and the like.

Further, as the substutuents, there are hydroxyl groups, mercapto groups, halogene atoms (fluorine atom, chlorine atom, bromine atom, iodine atom an the like), cyano groups, sulfo groups, carboxyl group, nitro group, hydroxsamic acid group, sulfino group, hydrazino group, imino group, heterocyclic group in which the number of the carbon atoms is preferably from 1 to 30, particularlu from 1 to 12 and there are nitrohgen atom, oxygen atom, sulfer atom and the like as the hetoroatom. As the hetetocyclic group, for example, there are imidazolyl group, pyridyl group, quinoryl group, furyl group, piperidyl group, morphorino group, benzooxazolyl group, benzimidazolyl group, benzthiazolyl group and the like. Further, as the substutuents, there are silyl group in which the number of the carbon atoms is preferably from 3 to 40, particularly from 3 to 30 and especially from 3 to 24, and there are trimethyl silyl, triphenyl silyl and the like. In the substituents, the subsitution may be further made. When there are two or more substituents, the sorts thereof may be the same or different. nitroten atom, oxygen atom sulfer atom and the like as the hetoroatom. Futher, the subsituents may form a cyclic group.

In followings chemical formulae, concrete examples of the compounds shown in Chemical formula 1 (formula (2)) will be illustrated. However, the present invention is not restricted in the concrete examples.

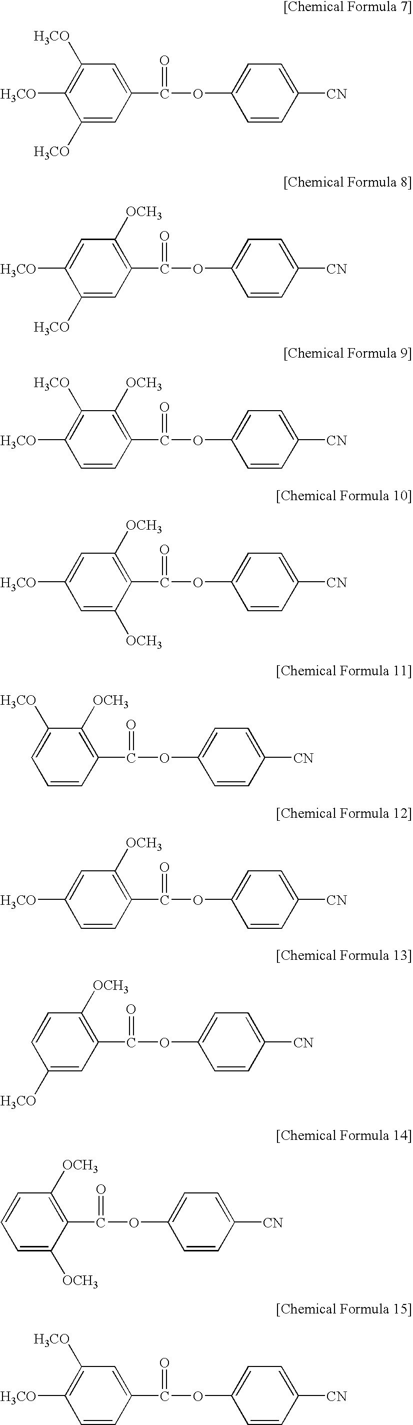

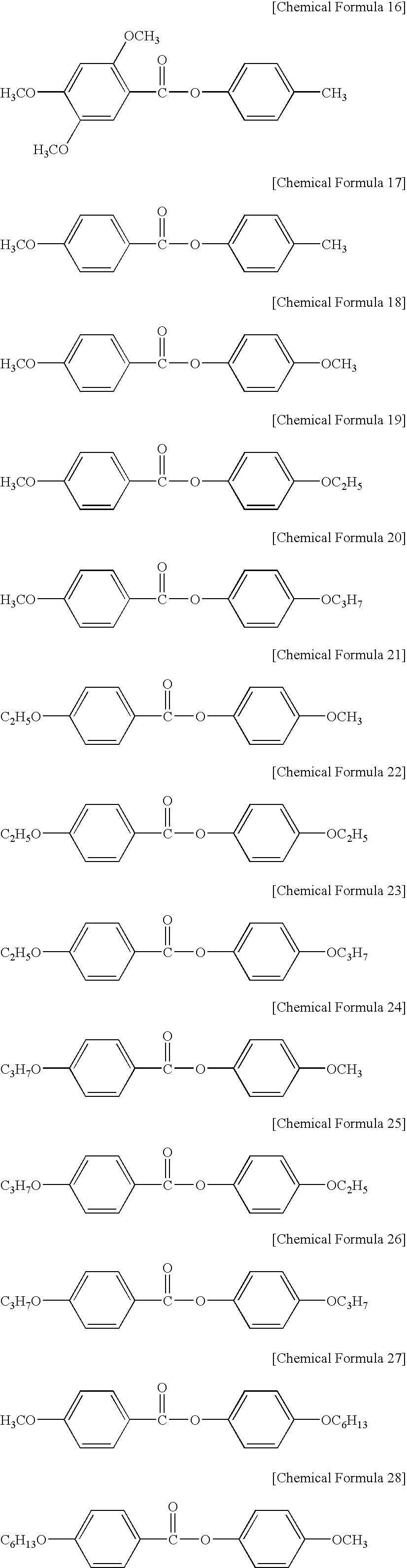

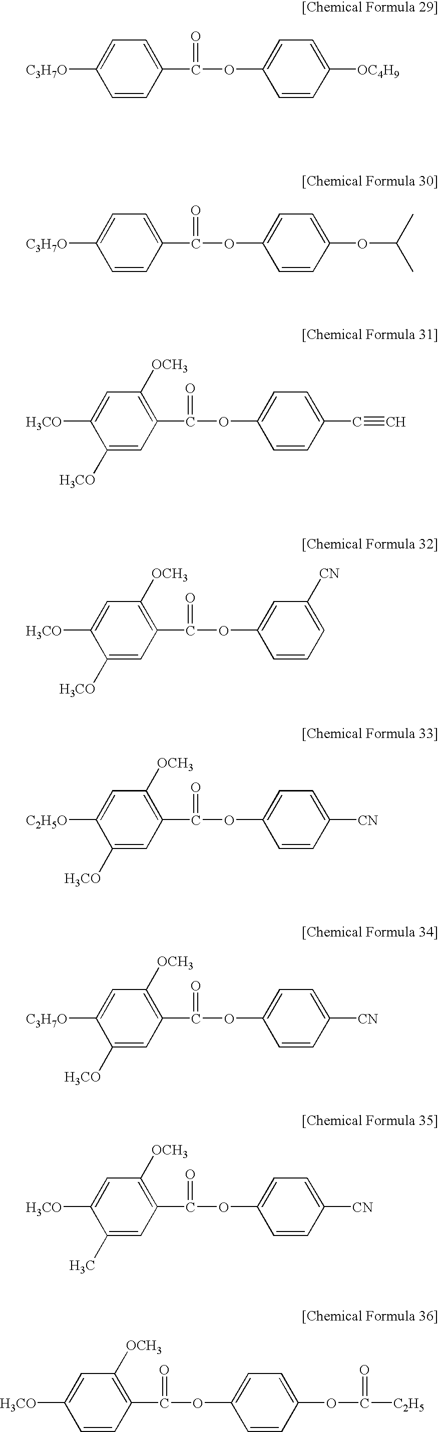

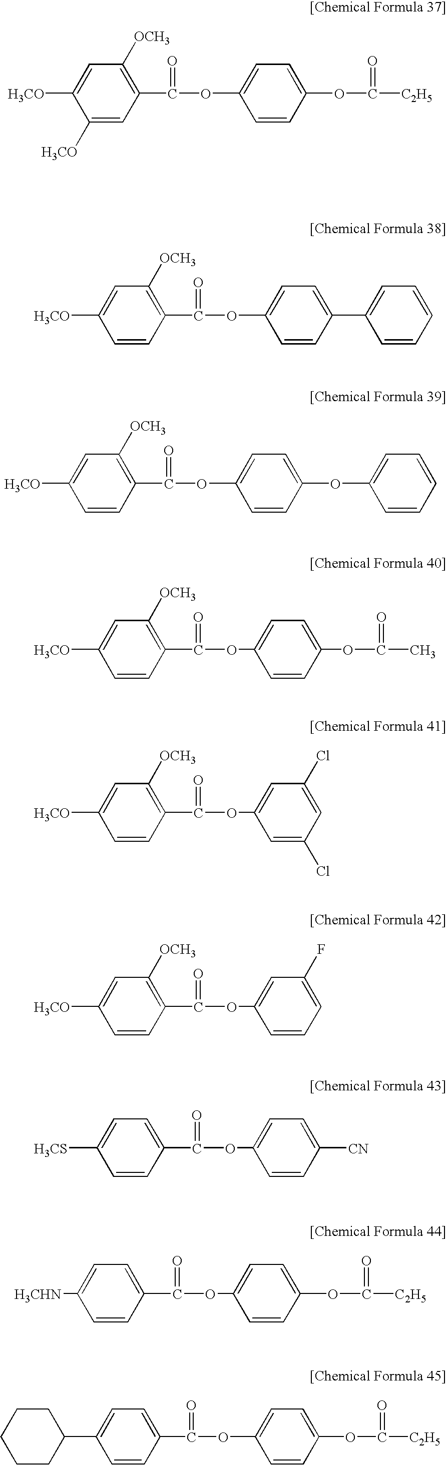

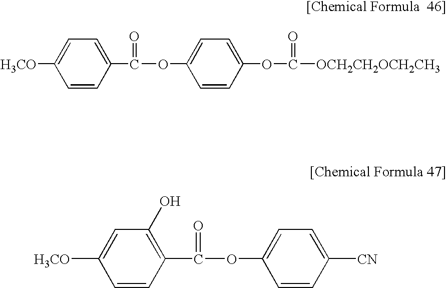

The compounds represented by Chemical Formula 1 (formula (2)) can be produced in a general esterification reaction of substituted benzoic acid and phenol derivatives. The method of the production is not restricted so far as being esterification reaction. For example, there are a method in which a functional group transformation of the substituted benzoic acid to an acid halide is made and thereafter a condensation with the phenol is made, a method in which the dehydration condensation between substituted benzoic acid and the phenol derivatives with use of condensation agent and catalyst, and the like. In consideration of the producing process, the method in which the phenol condensation is made after the functional group transformation of the substituted benzoic acid to the acid halide.

As the solvent for the reaction, there are hydrocarbon type solvent (preferably toluene, xylene and the like), ether type solvent (preferably dimethylether, tetrahydrofuran, dioxane and the like), ketone type solvent, ester type solvent, acetonitril, dimethylformamide, dimethylacetoamide and the like. Single one or the mixture of these compounds may be used as the solvent. Especially preferable solvents are toluene, acetonitril, dimethylformaldehyde, dimethylacetoamide and the like.

The reaction temperature is preferably in the range of 0° C. to 150° C., particularly in the range of 0° C. to 100° C., especially in the range of 0° C. to 90° C., and more especially 20° C. to 90° C. In this reaction, it is preferable not to use a base. When the base is used, the organic and inorganic bases may be used. However, the organic base is preferably used, and pyridine and tertiary alkylamine (preferably triethylamine, ethyldiisopropyl amine and the like) are particularly preferably used.

In the optical properties of celluloseacylate film of the present invention, retardation values Re,Rth are represented by formulae (III),(IV):
Re(λ)=(nx−ny)×d; Formula (III):
Rth(λ)={(nx+ny)/2−nz}×d Formula (IV):
The retardation values Re,Rth preferably satisfy following formulae (V),(VI):
46 nm≦Re(630)≦200 nm; Formula (V):
70 nm≦Rth(630)≦350 nm; Formula (VI):
[In formulae, Re(λ) is an in-plane retardation value (unit; nm) at λnm wavelength, Rth(λ) is a thickness retardation value (unit; nm) at λnm wavelength. Further, nx is a refractive index in the direction of the slow axis on a film surface, ny is a refractive index in the direction of the fast axis on a film surface, and nz is a refractive index in the thickness direction of the film. Further, d is the film thickness.]
The retardation values especially preferably satisfy following formulae (VII),(VIII):
46 nm≦Re(630)≦100 nm; Formula (VII):
180 nm≦Rth(630)≦350 nm; Formula (VIII):

The optical properties such as the retardation values Re,Rth change depending on a humidity variation, a mass variation and a period in which the high temperature is kept. Preferably, the change of the values Re,Rth are smaller. In order to reduce the change of the values Re,Rth, the moisture permeability and the equilibrium moisture content of the film is made smaller by using not only cellulose acylate whose degree of acylation at 6^{th} position is large, but also several sorts of hydrophobic additives (plasticizer, retardation controller, UV-absorbing agent and the like). The moisture permeability to cellulose acylate is preferably from 400 g to 2300 g in 1 square meter at 60° C. and 95% RH for 24 hours. The measured value of the equilibrium moisture content is preferably at most 3.4% at 25° C. and 80% RH. When the humidity at 25° C. varies from 10% RH to 80% RH, the retardation values Re,Rth of the optical properties respectively change at most 12 nm and at most 32 nm. The quantity of the hydrophobic additives is preferably from 10% to 30%, particularly from 12% to 25%, and especially 14.5% to 20%. If the additives is volatile and resoluble compounds, the mass variation and size variation of the film occur, which causes the change of the optical properties. Accordingly, after 48 hours passes at 80° C. and 90% RH, the mass variation of the film is preferably at most 5%. Similarly, after 24 hours passes at 60° C. and 95% RH, the size variation of the film is preferably at most 5%. Further, event though the size variation and the mass variation are small, the change of the optical properties becomes smaller under the smaller photoelastic coefficient. Therefore, the photoelastic coefficient is preferably at most 50×10⁻³ cm²/dyne.

The producing method of the dope used in the present invention is not restricted especially. An example of the producing method will be described in followings. The main solvent compound is dichloromethane, and the mixture solvent into which the alcohols are added was used. TAC and the plasticizers are added to the mixture solvent, and the dissolution with the stirring is made to obtain a primary dope. Note that in the dissolving, the heating and the cooling were made so as to increase the dissolubility. Further, the primary dope, the mixture solvent and the UV-absorbing agent (for example, benzotriazol type compound) are mixed and stirred to obtain an additive solution. Further, the primary dope, the mixture solvent and the matting agent are mixed and dispersed to obtain a matting liquid. Further, as to the object, an additive liquid containing the deterioration inhibitors, optical anisotropy controlling agent, a dye and a peeling agent may be prepared.

After the preparation of the primary dope and the additive liquid, in order to remove the impurities, a filtration is preferably made by a filtration apparatus. Particularly preferably, the filtration apparatus includes a filter whose averaged pore diameter is at most 100 μm, so as to perform the filtration at 50 L/hr flow rate of the filtration. Thereafter, foam are preferably removed from the primary dope and the additive solution.

Methods for dissolving materials, raw materials and additives, filtrating, removing the voids, and adding are explained in Japanese Patent Application No. 2003-319673. The description of this publication can be applied to the present invention.

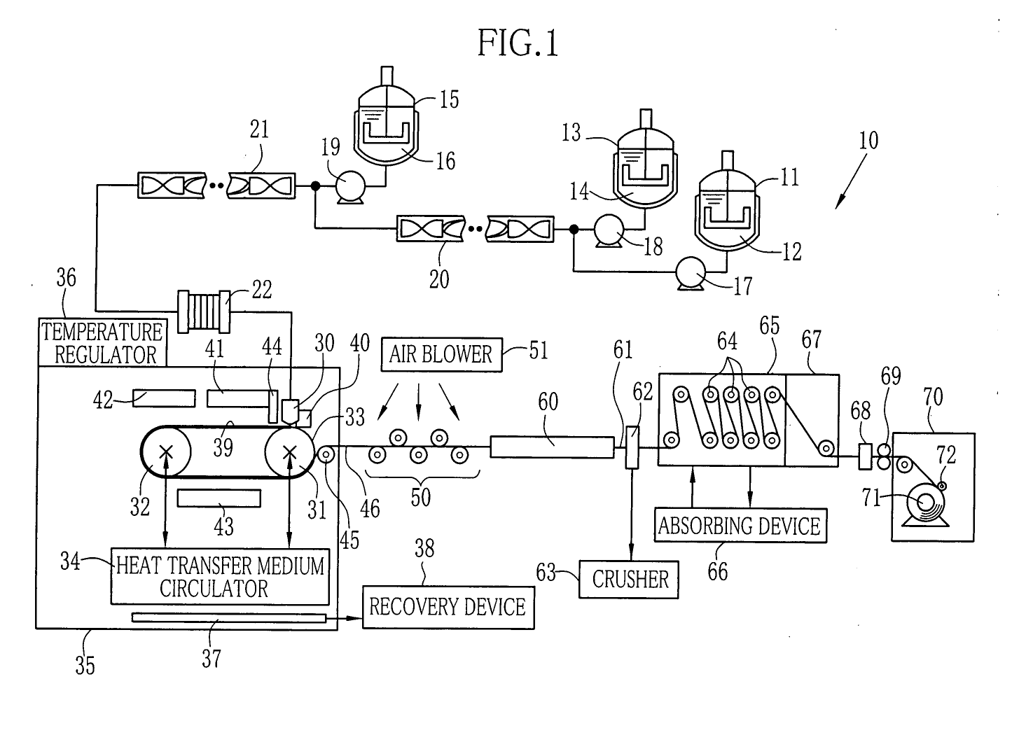

In FIG. 1, a film production line 10 includes a stock tank 11 containing an additive liquid 12, a stock tank 13 containing a matting agent liquid 14, and a stock tank 15 containing a primary dope 16. The stock tanks 11, 13,15 are respectively provided with pumps 17,18,19 for feeding the additive liquid 12, the matting agent liquid 14 and the primary dope 16 therein.

After mixing the additive liquid 12 and the matting agent liquid 14, they are fed through a static mixer 20 such that a uniform added liquid. Then, the added liquid is added to the primary dope 16 and the mixture is fed through a static mixer 21. Thus a uniform solution is obtained as a casting solution. After the filtration with use of a filtration apparatus 22, the casting dope is fed to a casting die 30.

Below the casting die 30, there is a belt 33 supported by rollers 31,32. The belt 33 endlessly and circulatory move in accordance with a rotation of the rollers 31,32 by a driving device (not shown). The moving speed of the belt 33, namely a casting speed is preferably in the range of 100 m/min to 200 m/min. Furthermore, the rollers 31,32 are connected to a heat transfer medium circulator 34 for keeping a surface temperature of the belt 33 to a predetermined value. In each roller 31,32, there is a heat transfer passage in which a heat transfer medium of the predetermined temperature is fed, so as to keep the temperature of the rollers 31,32 to the predetermined value. Thus the surface temperature of the belt 33 is controlled to the predetermined value. Note that the surface temperature is preferably from −20° C. to 40° C.

The casting die 30, the belt 33 and the like are contained in a casting chamber 35 to which a temperature regulator 36 is connected. The temperature in the casting chamber 35 is preferably in the range of −10° C. to 57° C. Further, a concentrator 37 is provided for concentrating a solvent vapor. The concentrated organic solvent is recovered into a recovering device 38, and the reproduction is made for reusing as the solvent for preparing the dope.

The casting die 30 casts the casting dope on the belt 33 to form a casting film 39, while the casting dope form a bead above the belt 33. Note that the temperature of the casting dope is preferably from −10° C. to 57° C. Further, in order to stabilize the formation of the bead, a decompression chamber 40 is preferably provided in a rear side of the bead, so as to control the pressure. The casting film 39 is conveyed by the moving belt 33, and at the same time it is preferable to feed a drying air from air blowers 41,42,43 such that the organic solvent may evaporate. Positions of the air feeders are a upper and upstream side, an upper and downstream side, and a lower side of the belt. However, the positions are not restricted in this figure. Further, the surface condition of the film sometimes changes when the drying air is applied onto the casting film 39 just after the formation thereof. In order to reduce the change of the surface condition, a wind shielding device 44 is preferably provided. Note that although the belt is used as a support in this figure, a drum may be used as the support. In this case, the surface temperature of the drum is preferably in the range of −20° C. to 40° C.

When having a self-supporting property, the casting film 39 is peeled as a wet film 46 from the belt with support of a peel roller 45. Thereafter, the wet film 46 is transported in an interval section 50 provided with plural rollers. In the interval section 50, a drying air at a predetermined temperature is fed from an air blower 51 such that the drying of the wet film 46 may proceed. The temperature of the drying air is preferably in the range of 20° C. to 250° C. Note that in the interval section 50, the rotational speed of the rollers in the upstream side is faster than those in the downstream side, so as to draw the wet film 46. Thus the wet film 46 is transported in a tenter dryer 60 so as to make the drying, while both side edges are held by the clips. Note that methods of transporting and drying will be explained later.

The drying and further a relaxation of the wet film 46 is performed the tenter dryer 60, such that the wet film 46 may be a film 61 containing a predetermined content of the solvent. Then the film 61 is transported into an edge slitting device for slitting off or trimming both edge portion of the film 61. The slit edge portions are conveyed to a crusher 63 with use of a cutter blower (not shown). The crusher 63 crushes the both edge portions into tips, which are reused for preparation of the dope in view of the cost. Note that the trapping of the both edge portions of the film may be omitted. However, it is preferable to trim them somewhere between the casting of the dope and the winding the film.

The film 61 is transported into a drying chamber 65 in which there are plural rollers 64. The temperature in the drying chamber 65 is not restricted especially, and preferably in the range of 50° C. to 200° C. The drying of the film 61 in the drying chamber 65 is made with wrapping around the rollers so as to evaporate the solvent. The drying chamber 65 is provided with an adsorbing device 66 for adsorbing the solvent vapor. The air from which the solvent vapor is removed is fed as the drying air again. Note that the drying chamber is preferably partitioned into plural partitions so as to vary the drying temperature. Further, it is preferable to provide a pre-drying chamber between the edge slitting device 62 and the drying chamber 65 so as to make the pre-drying of the film 61. In this case, the deformation of the film which is caused by the accelerate increase of the temperature of the film is prevented.

The film 61 is transported into a cooling chamber 67, and cooled to a room temperature. Note that a moisture control chamber (not shown) may be provided between the drying chamber 65 and the cooling chamber 67. In the moisture control chamber, an air whose moisture and temperature are controlled is fed toward the film 61. Thus the winding defect of the film is prevented when the film 61 is wound.

It is preferable to provide a compulsory neutralization device (neutralization bar) 68 such that the charged voltage may be in the range of −3 kV to +3 kV in transporting the film 61. In FIG. 1, the neutralization device 68 is disposed in a downstream side from the cooling chamber 67. However, the position of the neutralization device 68 is not restricted in this figure. Further, it is preferable to provide a knurling roller 96 for providing a knurling with an embossing processing. Note that the unevenness in the area in which the knurling is provided is preferably in the range of 1 μm to 200 μm.

At last, the film 61 is wound around a winding shaft 71 in a winding chamber 70. The winding is preferably made with applying a predetermined tension by a press roller 72, and it is preferable to change the tension from a start to an end of the winding little by little. The length of the film 61 to be wound is preferably at least 100 m, and a width thereof is preferably at least 600 mm, and especially from 1400 mm to 1800 mm. However, even if the width is more than 1800 mm, the present invention is effective. Further, in the present invention, the thickness of the film to be produced is in the range of 15 μm to 100 μm.

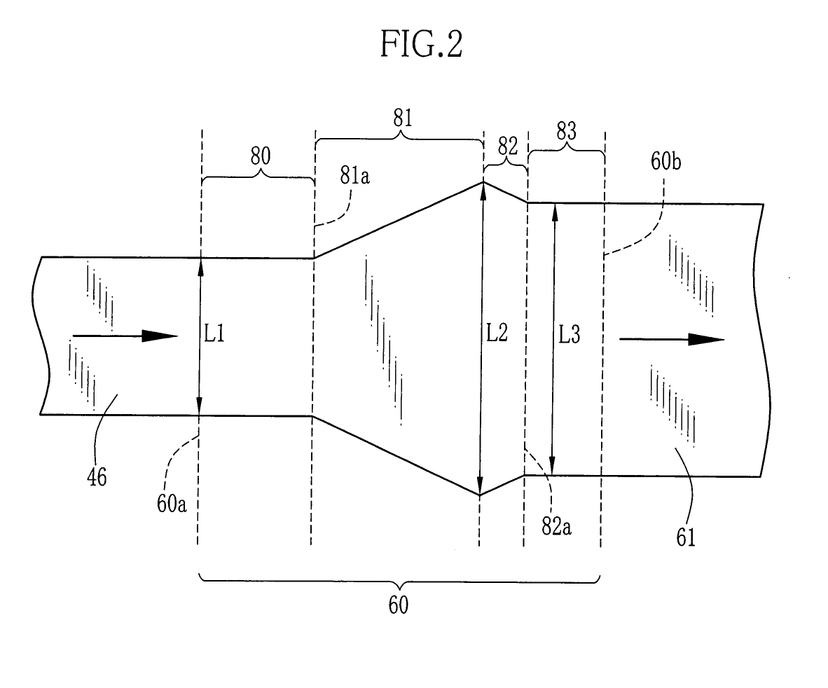

The stretch and the relaxation in the tenter dryer 60 will be explained in reference with FIG. 2. The wet film 46 peeled from the belt 33 as the support contains a predetermined content of the remaining solvent in which there are mainly organic compounds. The wet film 46 is further dried such that the content of the remaining solvent may be the predetermined one, and then both edge portions of the wet film 46 are held by holders (for example clips). Thus the width of passages of the holders is changed so as to make the stretch and a stretch relaxation (hereinafter, relaxation). The wet film 46 is held by the clips (not shown) at an entrance 60a. The temter device 60 has four sections depending on track separation. The four sections are constituted of an entrance section 80 for preheating and drying the wet film 46, in which the tracks of the holders are substantially uniform, a stretching section 81 for enlarging a film width, a relaxation section 82 for reducing a film width, and an exit section 83 in which the film thickness after the relaxation is substantially uniform. At an exit 60b in the exit section 83, the film is released from the clips and fed out from the tenter dryer 60.

The substantial uniformity of the film width at the entrance section 80 and the exit section 83 means that the difference of the film width between the start and the end of each section is equal to or less than ±2%. Since the wet film 46 contains the remaining solvent, the drying of the organic solvent is continuously made from the entrance section 80 to the exit section 83. Several sorts of methods of drying the device for drying the organic solvent can be applied to the present invention. However, the method of drying with feeding a hot air to the wet film 46 is especially preferable in view of the cost for the equipment.

In the present invention, a content difference X of the remaining solvent between a stretch start position 81a of the stretching section 81 and a relaxation end position 82a of the relaxation section 82 is regulated so as to control the bowing. The regulation of the content of the remaining solvent of the wet film may be made before the tenter dryer 60, or after the entering into the tenter dryer 60. In the latter case, the regulation of the content of the remaining solvent is made by changing the drying temperature. Preferably, the stretching section 81 is shifted into up- and backstream sides in a mechanical manner. In case of the constant drying temperature in the tenter dryer 60, the stretching section 81 is moved into the upstream side such that the content difference X(wt. %) of the remaining solvent increases, and the stretching section 81 is moved into the downstream side such that the content difference X(wt. %) of the remaining solvent decreases. As the especially preferable embodiment, a drying air whose temperature is constant is fed into a tenter dryer and the stretching section 81 is moved in front- and backwards, so as to control the content difference X (wt. %) of the remaining solvent. Thus the cost of the equipment is made minimal and the present invention can be effective independent from the variation of the stretching conditions.

The calculation method of the content difference X(wt. %) of the remaining solvent will be explained. The content of the remaining solvent in the film is calculated on the following formula:
Content of Remaining Solvent (wt. %)=(W1−W2)/W2×100
W1: weight(gw) of a film sample cut off so as to have a predetermined size
W2: weight (gs) of the film sample after the drying for one hour in an air thermostat vessel at 115° C.
   Further, the content difference of the remaining solvent is calculated on a formula:
   X(wt. %)=(content (%) of the remaining solvent at the stretch start point 81a)−(content (%) of the remaining solvent at the relaxation end point)

A maximal stretch ratio SRₘₐₓ(%) is calculated on a formula:
SRₘₐₓ(%)=(L2/L1)×100
L1: width between tracks of the clips at the entrance 60a of the tenter dryer 60
L2: maximal width of tracks of the clips in the tenter dryer 60
   Further, a stretch ratio after relaxation Rᵣₑₗ(%) is calculated on a formula:
   Rᵣₑₗ(%)=(L3/L1)×100
L3: width between tracks of the clips in the exit section 83 Furthermore a stretch speed Y(%/min) is calculated on a following formula:
   Y(%/min)=SRₘₐₓ/T1
T1: period for the transport in the stretching section 81 Further, a relaxation speed Z(%/min) is calculated on a following formula:
   Z(%/min)=(SRₘₐₓ−Rᵣₑₗ)/T2
T2: period for the transport in the relaxation section 82

In the present invention, the content difference X(wt. %) of the remaining solvent has a relation to the stretch speed Y(%/min), preferably
−5.0<0.27X+1.01XY−21.2<5.0
and particularly preferably,
−1.50<0.27X+1.01XY−21.2<1.50

The content (wt. %) of the remaining solvent at the stretch start position 81a, the content difference X (wt. %) of the remaining solvent, the stretch speed Y(%/min), the a relaxation speed Z(%/min), the maximal stretch ratio SRₘₐₓ(%), the stretch ratio after relaxation Rᵣₑₗ(%) and sorts and quantity of the additives to be added are regulated so as to reduce the generation of the bowing. An axial misalignment of the slow axis of the birefringence to the widthwise direction can be less than 2.0°, further less than 1.0°, and furthermore less than 0.5°.

The solution casting method of the present invention may be a co-casting method in which a co-casting of two or more sorts of the dopes are made such that the dopes may form a multi-layer film, or a sequentially casting method in which two or more sorts of the dopes are sequentially cast so as to form the multi-layer film. When the co-casting is performed, a feed block may be attached to the casting die, or a multi-manifold type casting die may be used. A thickness of each upper and lowermost layer of the multi-layer casting film on the support is preferably in the range of 0.5% to 30% to the total thickness of the multi-layer casting film. Furthermore, in the co-casting method, when the dope-is cast onto the support, it is preferable that the lower viscosity dopes may entirely cover over the higher viscosity dope. Furthermore, in the co-casing method, when the dope is cast onto the support, it is preferable that the inner dope is covered with dopes whose alcohol contents are larger.

Note that Japanese Patent Application No. 2003-319673 teaches in detail the structure of the casting die, the decompression chamber and the support, drying conditions in each processes (such as the co-casting, the peeling and the stretching), a handling method, a winding method after the correction of planarity and curling, a recovering method of the solvent, a recovering method of film and the like the description of the above publication may be applied to the present invention.

[Characteristics, Measuring Method]

This application No. 2003-319673 teaches the characteristics and the measuring method of the cellulose acylate film, which may be applied to the present invention.

[Surface Treatment]

It is preferable to make a surface treatment of at least one surface of the cellulose acylate film. Preferably, the surface treatment is at least one of glow discharge treatment, plasma discharge treatment, UV radiation treatment, corona discharge treatment, flame treatment, and acid and alkali treatment.

[Functional Layer]

A primary coating may be made over at least one surface of the cellulose acylate film. Further, it is preferable to provide other functional layers for the cellulose acylate film as a film base so as to obtain a functional material. The functional layers may be at least one of antistatic agent, cured resin layer, antireflection layer, adhesive layer for easy adhesion, antiglare layer and an optical compensation layer.

Preferably, the functional layer contains at least one sort of surface active agent in the range of 0.1 mg/m² to 1000 mg/m². Further, preferably, the functional layer contains at least one sort of lubricant in the range of 0.1 mg/m² to 1000 mg/m². Further, preferably, the functional layer contains at least one sort of matting agent in the range of 0.1 mg/m² to 1000 mg/m². Further, preferably, the functional layer contains at least one sort of antistatic agent in the range of 1 mg/m² to 1000 mg/m². Conditions and methods of performing a surface treatment and providing a functional layer with several functions and characteristics are described in Japanese Patent Application No. 2003-319673.

The cellulose acylate film can be used as the protective film for a polarizing filter. To obtain a LCD, two polarizing filters, in each of which the cellulose acylate film is adhered, are disposed so as to sandwich a liquid crystal layer. The application No. 2003-319673 discloses TN type, STN type, VA type, OCB type, reflection type, and other example in detail. To these types can be applied the film of the present invention. Further, the application teaches the cellulose acylate film provided with an optical anisotropic layer and that provided with antireflective and antiglare functions. Furthermore, the application supposes to provide the cellulose acylate film with adequate optical functions, and thus a biaxial cellulose acylate film is obtained and used as the optical compensation film, which can be used as the protective film for the polarizing filter simultaneously. The restriction thereof described in the application No. 2003-319673 can be applied to the present invention.

### EXAMPLE

Example of the present invention was explained. However, the present invention was not restricted in the example. In this example, Experiments 1-13 were performed. The explanation of Experiment 1 of the present invention was made in detail, and the same explanations of Experiments 2-10 of the preset invention and Experiments 11-13 as comparisons were omitted. Further, the conditions and the results of the examinations were respectively shown in Table 1&2.

(Preparation of Primary Dope)

| | |
|---|---|
| cellulose triacetate | 89.3 wt. % |
| (degree of substitution, 2.8) | |
| Triphenylphosphate | 7.1 wt. % |
| Biphenyldiphenylphosphate | 3.6 wt. % |

To these solid materials 100 pts.wt., a mixture solvent of following compounds was added:

| | |
|---|---|
| Dichloromethane | 87 wt. % |
| Methanol | 13 wt. % |

The mixture of the solid materials and the mixture solvent was stirred to make the dissolution so as to obtain the primary dope 16, in which the content of the solid materials was 19.0 wt. %. Then the filtration of the prepared dope was made.
(Preparation of Additive Liquid)

For preparation of the additive liquid, following compounds are used:

| | |
|---|---|
| Compound of Chemical Formula 48 | 20.0 wt. % |
| Primary Dope | 13.9 wt. % |

The compounds of Chemical Formula 48 was N,N′-di-m-tolyl-N″-p-methoxyphenyl-1,3,5-triazine-2,4,6-triamine, whose structure is shown in following:₃

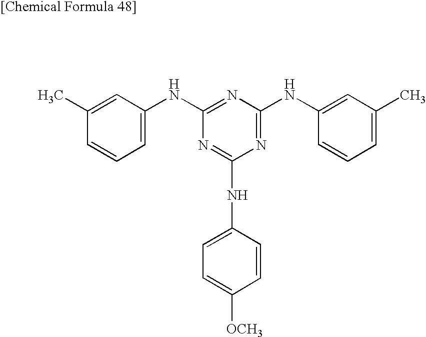

(Preparation of Matting Agent)

| | |
|---|---|
| Silica Particles | 2.0 wt. % |
| (R972 produced by Nippon Aerozil Co., Ltd.) | |
| Primary Dope | 15.6 wt. % |
| Dichloro Methane | 76.1 wt. % |
| Methanol | 11.3 wt. % |

The mixture of the above compounds was mixed and dissolved by an attritor to prepare the matting agent liquid 14.

Then the matting agent liquid 14 was mixed with the additive liquid 12 with use of the static mixer 20, and further a mixture liquid of the additive liquid 12 and the matting agent liquid 14 was mixed by the static mixer 21. The casting die 30 to be used was 1.8 m in width. The casting was made with regulating a flow rate of the dope from the casting die 30, such that the thickness of the produced film might be 80 μm and the width of the casting might be 1700 mm. In order to regulate the temperature of the dope to 36° C., a jacket (not shown) is provided with the casting die, and a heat transfer medium (water) whose temperature was controlled to 36° C. at an entrance of the jacket was fed into the jacket.

At producing the film, the temperatures of the casting die 30 and pipes are kept to 36° C. Further, the casting die 30 was coathanger type, in which bolts for adjusting the thickness of the film are provided with pitch of 20 mm. Then the adjustment was made with use of the bolts. Thus, in the film except of the 20 mm edge portions, the difference of the thickness at any two points apart at 50 mm was at most 1 μm, and further the difference of the minimal thickness values in the widthwise direction was at most 3 μm/m. The adjustment was made such that the change of the film thickness might be reduced in the range of ±1.5% to the averaged film thickness.

In a primary side from the casting die 30, the decompression chamber 40 was disposed, whose decompression rate can be adjustable depending on the casting speed, such that there would be a pressure difference in the range of 1 Pa to 5000 Pa between up- and downstream sides. Further, the temperature of the decompression chamber was also regulated there was labyrinth packing (not shown) in front and rear sides of the bead. Further, there were openings in both sides. Further, in order to compensate the disorder of the both edges of the casting beads, an edge suctioning device (not shown) was used.

The material of the casting die 30 was a precipitation hardened stainless or a stainless having double-layer structure. The material had coefficient of thermal expansion of at most 2×10⁻⁵(° C.⁻¹), the almost same anti-corrosion properties as SUS316 in examination of corrosion in electrolyte solution. Further, when the material was dipped in a mixture liquid of dichloromethane, methanol and water, pitting (holes) were not formed on the gas-liquid interface. The finish precision of a contacting surface of the casting die 30 to the dope was at most 1 μm/m, and the clearance of the slit was automatically controlled in the range of 0.5 mm to 3.5 mm. In this embodiment, the slit clearance was 1.5 mm. An end of the contacting portion of each lip to the dope was processed so as to have a chamfered radius at most 50 μm through the slit. In the die, the shearing speed was in the range of 1(1/sec) to 5000(1/sec).

Further, lip ends are provided with a hardened layer. In order to provide the hardened layer, there are methods of ceramic coating, hard chrom plating, nitriding treatment and the like. If the ceramics is used as the hardened layer, the grind was possible, the porosity becomes lower, and was not friable and the good corrosion resistance. Further, as the preferable ceramics, there was no adhesive properties to the casting die. Concretely, as the ceramics, there are tungsten carbide, Al₂O₃, TiN, Cr₂O₃ and the like, and especially tungsten carbide. Note in the present invention the hardened layer was formed by a tungsten carbide coating in a spraying method.

On the both edges of a die slit, the discharged dope is partially dried to be a solid. In order to prevent the solidification of the dope, a mixture solvent to which the dope was dissoluble was supplied at 0.5 ml/min to beads edges and the air-liquid interface of the slit. The pump for supplying the dope has a pulsation at most 5%. Further, the pressure in the rear side (or the upstream side) of the bead was decreased by 150 Pa. Further, in order to make the temperature in the decompression chamber 40 constant, a jacket (not shown) was provided. Into the jacket, a heat transfer medium whose temperature was regulated to 40° C. was fed. The airflow of the edge suctioning was in the range of 1 L/min to 100 L/min, and in this embodiment, the air flow rate was regulated in the range of 30 L/min to 40 L/min.

The belt 33 was a stainless endless belt that was 2.0 m in width and 70 m in length. The thickness of the belt 33 was 1.5 mm and the polishment was made such that a surface roughness was at most 0.05 μm. The material was SUS 316 and had enough corrosion resistance and strength. The thickness unevenness of the belt 33 was at most 0.5%. The belt 33 was rotated by drive of two rollers 31,32. At this time, a tension to the belt 33 was regulated to 1.0×10⁴ kg/m, and the difference of the relative speed of the rollers 31,32 and the belt 33 was at most 0.01 m/min. Further, the velocity fluctuation of the belt 33 was at most 0.5%. The rotation was regulated with detecting the positions of both edges such that the film meandering in widthwise direction for one rotation might be regulated to at most 1.5 mm. Further, the positional fluctuation in horizontal directions of the lips and the canting belt just below the casting die 30 was at most 200 μm.

Into the rollers 31,32 are fed the feed transfer medium so as to perform the temperature regulation of the belt 33. Into the roller 31 in a side of the casting die was fed the heat transfer medium (water) at 20° C. and into the roller 32 was fed the heat transfer medium (water) at 40° C. The surface temperature of the middle portion of the belt 33 just before the casting was 15° C., and the temperature difference between both side edges was at most 6° C. Note that the belt 33 preferably had no defect on surface, and especially preferably, the number of pin holes whose diameter was at least 30 μm was zero, that of the pinholes whose diameter was from 10 μm to 30 μm was 1 per 1 m², and that of the pinholes whose diameter was less than 10 μm was 2.

The temperature of the casting chamber 35 was kept to 35° C. The dope 33 is cast onto the belt 33 to form the casting film 39, to which the drying air of parallel flow to the casting film 39 was fed at first to dry. Airs were fed from the air blowers 41-43 such that the temperature of the drying air might be 135° C. in an upper and upstream side, 140° C. in a upper and downstream side, and 65° C. in a lower side. The saturated temperature of each drying wind was about −3° C. Then the wet film 46 was peeled from the belt 33. In order to reduce the peeling defect, the peeling speed to the moving speed of the belt was 100.5%. The solvent vapor generated by the drying was condensed by the concentrator 37 and then recovered into the recovery device 38. The drying air from which the solvent vapor was removed was heated again and reused as the drying air. The wet film 46 was transported in the interval portion 50 with use of 5 rollers toward the tenter dryer 60. At the same time, the water content in the solvent was regulated to at most 0.5% to reuse the solvent. During the transporting in the interval portion 50, the drying air at 70° C. was fed from the air blower 51.

The wet film 46 transported into the tenter dryer 60 was further transported in the entrance section 80 without changing the width (see, FIG. 2). The content of the remaining solvent at the stretch start position 81a was 36.2 wt. %, and the drawing was made at the drawing speed of 0.79%/min until the maximal stretch ratio might be 24.3%. Thereafter, in the relaxation section 82, the relaxation for decreasing the width was made such that stretch ratio after the relaxation and the relaxation speed might be respectively 19.2% and 0.68%/min. The content difference X of the remaining solvent was 19.8 wt. %. After the transport in the exit section 83 with keeping the width, the wet film 48 was fed out as the film 61 from the tenter dryer 60. In the tenter dryer 60, the heating air of 140° C. was controlled such that a wind speed in the widthwise direction might be constant, and fed out into a normal direction of the film through nozzles (not shown) intermittently disposed.

Then, the edge slitting of both edge portions was made in 30 minutes after exit from the tenter dryer 60. Before drying at the high temperature in the drying chamber 65 which will be explained later, the preheating of the film 61 was made in a predrying room (not shown) into which the drying air at 100° C. was fed.

The film 61 was dried at high temperature in the drying chamber 65. In a former part of the drying chamber 65, the hot air at 120° C. was supplied, and in a latter part, the hot air at 130° C. was supplied. Thereafter, the unnecessary side edge portions were trimmed. Note that the tension of transporting the film 61 by the roller 64 in the drying chamber was 100N/width, and the drying was made for about 30 minutes such that the content of the remaining solvent might be less than 0.2 wt. %. The material of the roller 64 was aluminum or carbon steel, and a hard chrome coating was made on a surface or periphery. Two types of the rollers 64 were used. In the first type, the surface of the roller 64 was flat, and in the second type, the blasting was made for the matting process on the surface. The positional fluctuation (or eccentricity) in the rotation of the roller 64 was at most 50 μm, and the bending of the roller 64 at the tension of 100N/width was 0.5 mm.

The solvent vapor in the drying air was removed by the adsorbing device 66. The adsorptive agent was activated carbon, and the desorption was mad with the dried air. Thus the water content of the recovered solvent was made at most 0.3 wt. %, and thereafter the recovered solvent was used for the solvent for preparing the dope. The drying air includes not only the solvent vapor but also other compounds such as plasticizer, UV-absorbing agent and compounds of high boiling points. Therefore the other compounds are removed with cooling by cooling device and a preadsorber, and recycled. Then the adsorption and desorption conditions were set such that VOC (volatile organic compounds) in the exhaust gas might become at most 10 ppm. Both edge portions were trimmed and then knurling of the both sides of the film 61 was made by a knurling roller 69. The knurling was performed by embossing process from a side. The pressure of the knurling was regulated, such that averaged width of the knurling might be 10 mm, and the maximal height might be 12 μm larger than the averaged thickness.

Thereafter, the film 61 was transported into the winding chamber 70 in which the temperature was 28° C. and the humidity was 70%. Further, an ionizer (not shown) was disposed in the winding chamber 70 such that the charged voltage might be in the range of −1.5 kV to +1.5 kV. Thus the film 61 was obtained to have the thickness of 80 μm and the width of 1340 mm. The diameter of the winding shaft 71 was 169 mm. The tension was 250N/width in the beginning of winding and 220N/width in the end of winding. The total length of the wound-up film was 2640 m. The length of the film to be wound around the winding shaft was 400 m, and the oscillation range was from −5 mm to +5 mm. In the winding, the temperature of the film was 25° C., and the water content was 1.4 wt, %, the content of the remaining solvent was less than 0.2 wt. %. The content of the compound of chemical formula 48 in the film was 4.7 wt. %, and the content of the silica particles was 0.13 wt. %.

Samples were obtained at the positions 50 mm apart from the both edges of the produced film and at a center of the produced film, with use of a cutting plotter. Then an angle of the slow axis to a widthwise direction (or an in-plane and perpendicular direction to a lengthwise direction) and a Re value in luminance at 632.8 nm were measured with use of KOBRA-21DH (produced by Oji Scientific Instrument). The axial misalignment of the slow axis of the birefringence to the widthwise direction of the film was the maximal value of the results of the measurement of the three samples, the averaged of the measured Re value was regarded as the result of Re-value. As the result, The Re value was 38.8 nm, and the axial misalignment was 0.2°. Further, the content difference X of the remaining solvent was 19.8 wt. %, the stretch speed Y was 0.79%/min, and the value calculated from the formula (1) was 0.1. Further, the content of the compounds of Chemical Formula 48 was measured by spectroscopic absorption, and the measured value was 4.3 wt. %. The bowing was measured at the measurement angle for the axial misalignment, and as the result, the measured value was almost zero (estimation A).

TABLE 1

| | CSₛₜᵣ | X(ΔCSₛₜᵣ) | Y(Sₛₜᵣ) | Sᵣₑₗ | SRₘₐₓ | SRᵣₑₗ |
|---|---|---|---|---|---|---|
| | (wt. %) | (wt. %) | (%/min) | (%/min) | (%) | (%) |
| Ex. 1 | 36.2 | 19.8 | 0.79 | 0.68 | 24.3 | 19.2 |
| Ex. 2 | 35.3 | 19.2 | 0.80 | 0.69 | 24.5 | 19.3 |
| Ex. 3 | 38.1 | 28.1 | 0.48 | 0.27 | 24.6 | 19.1 |
| Ex. 4 | 42.5 | 28.2 | 0.49 | 0.62 | 22.3 | 17.6 |
| Ex. 5 | 38.1 | 26.5 | 0.60 | 0.27 | 24.6 | 19.1 |
| Ex. 6 | 30.0 | 20.0 | 0.60 | 0.27 | 24.6 | 19.1 |
| Ex. 7 | 41.4 | 27.4 | 0.64 | 0.34 | 24.5 | 19.3 |
| Ex. 8 | 35.3 | 21.3 | 0.80 | 0.34 | 24.5 | 19.3 |
| Ex. 9 | 30.7 | 16.4 | 0.73 | 0.62 | 22.3 | 17.6 |
| Ex. 10 | 36.2 | 21.9 | 0.58 | 0.62 | 22.3 | 17.6 |
| Ex. 11 | 27.0 | 20.0 | 0.40 | 0.18 | 24.6 | 19.1 |
| Ex. 12 | 36.0 | 26.0 | 0.80 | 0.27 | 24.6 | 19.1 |
| Ex. 13 | 30.7 | 13.0 | 0.85 | 0.62 | 22.3 | 17.6 |

CSₛₜᵣ: content of remaining solvent at start of stretch
X(ΔCS): content difference of remaining solvent
Y(Sₛₜᵣ): stretching speed
Sᵣₑₗ: relaxation speed
SRₘₐₓ: maximal value of stretch ratio
SRᵣₑₗ: stretch ratio after relaxation

TABLE 2

| | Value of | WR | Re | Axial | |
|---|---|---|---|---|---|
| | Formula(1) | (CF48) | (nm) | misalignment | Bowing |
| Ex. 1 | −0.1 | 4.3 | 38.8 | 0.2° | A |
| Ex. 2 | −0.5 | 4.9 | 39.8 | 0.2° | A |
| Ex. 3 | 0.0 | 4.7 | 39.4 | 0.2° | A |
| Ex. 4 | 0.4 | 4.3 | 34.2 | 0.3° | A |
| Ex. 5 | 2.0 | 4.7 | 39.5 | 1.0° | B_{f} |
| Ex. 6 | −3.7 | 4.7 | 39.7 | 0.7° | B_{b} |
| Ex. 7 | 3.9 | 4.7 | 39.9 | 1.3° | B_{f} |
| Ex. 8 | 1.8 | 4.7 | 39.0 | 0.6° | B_{f} |
| Ex. 9 | −4.7 | 4.3 | 33.9 | 1.7° | B_{b} |
| Ex. 10 | −2.5 | 4.3 | 34.0 | 0.7° | B_{b} |
| Ex. 11 | −7.7 | 4.7 | 39.2 | −3.1° | N_{b} |
| Ex. 12 | 6.8 | 4.3 | 38.2 | 33° | N_{f} |
| Ex. 13 | −6.5 | 4.3 | 34.1 | −2.8° | N_{b} |

Formula (1): 0.27X + 1.01XY − 21.2
WR(CF48): weight ratio of compound of Chemical Formula 48
Estimation of Bowing:
A; almost flat
B_{f}; forward bowing having no influences on practical use
B_{b}; backward bowing having no influences on practical use
N_{f}; forward bowing inadequate for optical use
N_{b}; backward bowing inadequate for optical use

In Experiments 2&4, it was hard to recognize the bowing phenomena (A). In experiments 5, 7&8, the forward bowing was observed but has not influences on practical use (B_{f}). In experiments 6, 9&10, the backward bowing was observed but has not influences on practical use (B_{b}). In the film produced by the solution casting method of the present invention, the axial misalignment to the widthwise direction was at most 2° and therefore low, and could be decreased to less than 0.5° by selecting the experimental condition.

Experiments 11-13 were comparisons of this embodiment. In Experiments 11, 13, the backward bowing was observed such that the produced film was not adequate for optical use (N_{b}). In Experiment 12, the forward bowing was observed such that the produced film was not adequate for optical use (N_{f}).

After the saponification of the film produced in Experiment 3 as an example of the present invention, the film was adhered to a surface of a polarized film, and FUJITA produced by Fuji Photo Film Co., Ltd. (trade name; 80 μm) was adhered to another surface of the polarized film. Thus a polarizing filter was obtained, and used instead of the retardation film and the polarizing filter of VA-type (vertical alignment type) liquid crystal display. Then the image was displayed in a good condition.

Various changes and modifications are possible in the present invention and may be understood to be within the present invention.

1. A solution casting method comprising steps of:
casting a dope onto a support, said dope containing a polymer and a solvent;
drying said dope;
peeling said dope as a film;
enlarging a width of said film by stretching said film with holding both side edge portions of said film by a holding device;
performing a relaxation with continuing the holding, such that said width becomes shorter by a predetermined value; and
wherein when X is defined as a content difference (wt. %) of a remaining solvent in said film between starting the enlarging and ending the relaxation and Y is defines as an stretching speed (%/min) in the enlarging, the stretching and the relaxation are performed so as to satisfy a following formula,
−5.0<0.27X+1.01XY−21.2<5.0

2. A solution casting method described in claim 1, wherein said polymer is cellulose acylate.

3. A solution casting method described in claim 1, wherein a temperature for heating said film is almost constant during the stretch and the relaxation.

4. A solution casting method described in claim 1, wherein a misalignment of a slow axis of birefringence to a widthwise direction of said film is less than 2°.
